(19) United States
(12) Patent Application Publication
(10) Pub. No.: US 2025/0084222 A1
(43) Pub. Date: Mar. 13, 2025

(54) CURABLE COMPOSITION AND METHOD FOR PRODUCING CURED FILM

(71) Applicant: Konica Minolta, Inc., Tokyo (JP)

(72) Inventors: Masashi IKEDA, Tokyo (JP); Kouji IZAWA, Tochigi (JP)

(21) Appl. No.: 18/825,011

(22) Filed: Sep. 5, 2024

(30) Foreign Application Priority Data
Sep. 13, 2023 (JP) 2023-148490

(51) Int. Cl. C08J 3/28; C08J 7/18; C08K 5/101; C09D 11/322

(52) U.S. Cl. CPC C08J 3/28; C08J 7/18; C08K 5/101; C09D 11/322; C08J 2357/10

(57) ABSTRACT

A curable composition cured by irradiation with active rays. The content of a monofunctional polymerizable compound having a melting point of 25° C. or less is 5-50% by mass; the content of a polyfunctional polymerizable compound is 50-95% by mass. When a nanoindentation evaluator is used to press an indenter into a cured film (obtained by curing a coating film with an average thickness of 8 μm by irradiation with an active ray at a cumulative light amount of 400 mJ/m²) by 100 nm in the thickness direction, P1 is a load amount required for pressing, and P2 is a load amount after the pressing is maintained for 2 seconds, the cured film satisfies conditions (1) and (2): (1) P2 is 20 μN or less, and (2) A relaxation rate determined by an expression ((P1−P2)/P1×100) is 15% or more.

### CROSS REFERENCE TO RELATED APPLICATIONS

The entire disclosure of Japanese Patent Application No. 2023-148490 filed on Sep. 13, 2023, is incorporated herein by reference in its entirety.

### BACKGROUND

### Technological Field

The present invention relates to a curable composition and a method for producing a cured film.

### Description of Related Art

A cured film formed by applying a curable composition including a polymerizable compound and curing the composition by irradiation with active rays has a feature such as a high film hardness and high scratch resistance. Therefore, a cured film formed from the curable composition is used in various fields such as images and various electronic devices.

On the other hand, a cured film formed from the curable composition is less likely to be deformed following deformation of the base material. Therefore, the cured film is easily broken during a folding process or the like. A curable composition capable of increasing followability to deformation of a base material while maintaining strength of a cured film is known. For example, Japanese Unexamined Patent Publication No. 2016-172841 No. describes a monofunctional monomer-rich curable composition in which a monofunctional monomer having a high glass transition temperature (Tg) and a monofunctional monomer having a low Tg are combined.

Japanese Unexamined Patent Publication No. 2016-172841 describes that a cured film obtained from the composition described in this literature has both strength and followability to deformation of a base material (stretchability). According to the investigation by the present inventors, the cured film obtained from the composition described in Japanese Unexamined Patent Publication No. 2016-172841 has followability to the deformation of the base material to the deformation. On the other hand, when a base material with the cured film formed thereon (e.g., printing paper having an image formed thereon) is cut, cracking tends to occur in the vicinity of the cut portion. In particular, when a plurality of printed sheets on which images have been formed are stacked and cut, a difference in the quality of the cut portion is more likely to occur between the uppermost image and the second and subsequent images.

### SUMMARY

The present invention has been made in consideration of the above-described circumstances. The present invention provides a curable composition that can be used to produce a cured film that has both the followability to deformation of a base material and the suppression of cracking near a cut portion, in particular, a cured film that suppresses a change in properties among base materials when a plurality of base materials are stacked and cut. The present invention also provides a method for producing a cured film using the curable composition.

In order to realize at least one of the above-described objects, a curable composition reflecting one aspect of the present invention is a composition that contains a polymerizable compound and is cured by irradiation with active rays. The content of a monofunctional polymerizable compound that has a melting point of 25° C. or less is 5% by mass or more and 50% by mass or less based on a total mass of the polymerizable compound; the content of a polyfunctional polymerizable compound is 50% by mass or more and 95% by mass or less based on the total mass of the polymerizable compound; and when a nanoindentation evaluator is used to press an indenter into a cured film by 100 nm in a thickness direction of the cured film, P1 is defined as a load amount required for pressing, and P2 is defined as a load amount after the pressing is maintained for 2 seconds, the cured film satisfies both of conditions (1) and (2) below, the cured film being obtained by applying the curable composition to a base material to form a coating film having an average thickness of 8 μm, and curing the coating film by irradiation with an active ray at a cumulative light amount of 400 mJ/m²:
(1) the P2 is 20 μN or less, and
(2) a relaxation rate obtained by an expression ((P1−P2)/P1×100) is 15% or more.

### BRIEF DESCRIPTION OF DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1A is a graph which illustrates a typical result when a load measurement with a nanoindentation evaluation apparatus was performed on a cured film formed from a conventional curable composition, FIG. 1B is a graph which illustrates a typical result when the load measurement with the nanoindentation evaluation apparatus was performed on a cured film having increased flexibility as described in PTL 1, and FIG. 1C is a graph which illustrates a typical result when the load measurement with the nanoindentation evaluation apparatus was performed on a cured film formed from the curable composition according to the present embodiment;

FIG. 2 is a schematic view illustrating a configuration of an apparatus for producing a cured film.

### DETAILED DESCRIPTION OF EMBODIMENTS

Hereinafter, one or more embodiments of the present invention will be described with reference to the drawings. However, the scope of the invention is not limited to the disclosed embodiments.

### 1. Curable Composition

One embodiment of the present invention relates to a curable composition that contains a polymerizable compound to be polymerized by irradiation with active rays and is cured by polymerization of the polymerizable compound when irradiated with active rays.

### 1-1. Polymerizable Compound

The polymerizable compound may be a compound which is polymerized by irradiation with active rays, and may be a radically polymerizable compound or a cationically polymerizable compound. Among these, radically polymerizable compounds are preferable. Examples of the active rays include electron beams, ultraviolet rays, α-rays, γ-rays, and X-rays. Among these, ultraviolet rays and electron beams are preferable, and ultraviolet rays are more preferable.

Examples of the first polymerizable compound as the radically polymerizable compound include unsaturated carboxylate ester and (meth)acrylate. Of these, (meth)acrylates are preferred. In the present specification, “(meth)acrylate” means acrylate or methacrylate, and “(meth)acrylic” means acrylic or methacrylic.

The curable composition is a composition that allows obtainment of a cured film satisfying both of the conditions (1) and (2) below when a coating film having an average thickness of 8 μm is formed by applying the curable composition to a base material and curing the coating film by irradiation with active rays at a cumulative light amount of 400 mJ/m². Note that using a nanoindentation evaluation apparatus, the load amount required for pressing the cured film by 100 nm in the thickness direction is used as the P1, and the load amount after the pressing is maintained for 2 seconds is used as the P2.
(1) A relaxation rate obtained by an expression ((P1−P2)/P1×100) is 15% or more
(2) P2 is 20 μN or less

As described in PTL 1, a curable composition containing a large amount of a monofunctional monomer can increase the flexibility of a cured film formed therefrom. Therefore, a cured film having high followability to a base material can be formed from such a composition. On the other hand, in a case where the flexibility of the cured film is increased, when a plurality of base materials each having a cured film formed thereon are stacked and cut, cracking tends to occur in the vicinity of the cut portion.

According to the findings of the present inventors, it is considered that a continuous stress is generated in the cured film formed on the uppermost base material while the cutting blade is being brought into contact with and pressed into the cured film. On the other hand, it is considered that large shear stress is instantaneously generated in the cured films formed on the second and subsequent base materials due to the movement of the cutting blade that cuts the laminated cured films and the base materials. As described above, the cured film formed on the uppermost base material is different from the cured films formed on the second and subsequent base materials in the qualities of stresses, causing fracture, and thus different fractures are more likely to occur. Therefore, it is considered that a difference is more likely to occur in the qualities of the cut portions.

It is desirable that the cured film formed on the uppermost base material has flexibility to such an extent that the cured film is easily deformed in response to the pressing of the cutting blade in order to suppress cracking due to the continuous stress described above, and that the stress can be relaxed by the deformation.

In addition, in order to suppress cracks due to the above-described instantaneous stress, it is desirable that the cured films formed on the second and subsequent base materials have a strength to the extent that they can withstand the instantaneous load. That is, in order to suppress cracking at the time of cutting when the cured film is formed on the second or subsequent base material, it is desirable that the cured film has a characteristic that the load required at the moment of pressing the cutting blade is large (the strength is high).

These characteristics can be confirmed by pressing an indenter into the cured film with a nanoindentation evaluation apparatus and measuring the load amount when the pressed state (the pressing) is maintained.

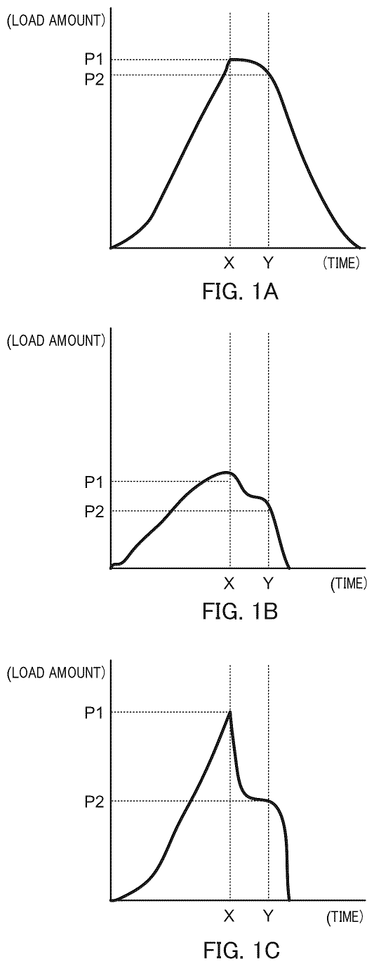

FIG. 1A is a graph illustrating a typical result when a cured film formed from a conventional curable composition is subjected to load measurement using a nanoindentation evaluation apparatus. FIG. 1B is a graph illustrating a typical result when the load measurement by the nanoindentation evaluation apparatus is performed on a cured film having increased flexibility as described in PTL 1. FIG. 1C is a graph illustrating a typical result when the load measurement by the nanoindentation evaluation apparatus is performed on a cured film formed from the curable composition according to the present embodiment. In each of FIGS. 1A to 1C, the horizontal axis indicates the time from the start of pressing of the indenter, and the vertical axis indicates the load amount at that time. Time X is defined as the time when the indenter is pressed 100 nm into the cured film, and time Y is defined as the time when the state in which the indenter is pressed 100 nm is maintained for 2 seconds from time X.

As illustrated in FIG. 1A, since the cured film formed from the conventional curable composition has high strength, the load amount P1 at time X is large, but the load P2 at time Y is also large similarly. Such a cured film does not tend to relax stresses ((P1−P2) is small), and therefore, when the base materials having the cured films formed thereon are stacked and cut, a crack tends to occur in the cured film formed on the uppermost base material in the vicinity of the cut portion. In addition, since such a cured film has a large load amount P2 and low flexibility, the cured film is less likely to follow the deformation of the base material and thus is more likely to be broken at the time of folding processing or the like.

The cured film having enhanced flexibility as illustrated in FIG. 1B has a low load amount P1 at time X and a low load amount P2 at time Y. Such a cured film has high flexibility (P2 is low), and therefore more likely to follow deformation of the base material, and less likely to be broken during folding processing or the like. However, such a cured film is less likely to relax stresses ((P1−P2) is small), and therefore, when the base materials having the cured films formed thereon are stacked and cut, a crack tends to occur in the cured film formed on the uppermost base material in the vicinity of the cut portion. In addition, since the strength of the cured film is low (P1 is small), the cured film is easily broken by shear stress due to a cutting blade at the time of cutting, and cracks are easily generated in the cured films formed on the second and subsequent base materials.

In contrast, the curable composition according to the present embodiment can form a cured film having a high load amount P1 at time X and a low load amount P2 at time Y. Such a cured film has high flexibility (P2 is small), and therefore more likely to follow deformation of the base material, and less likely to be broken during folding processing or the like. Furthermore, since the stress relaxing property is high ((P1−P2) is large), the cured film formed on the uppermost base material is less likely to be cracked. Furthermore, since the strength of the film is high (the P1 is high), when the base materials on which the cured film is formed are stacked and cut, the cured films formed on the second and subsequent base materials are less likely to be broken by shear stress due to the cutting blade at the time of cutting, and cracking is less likely to occur. Furthermore, a cured film having a high stress relaxation rate has high abrasion resistance.

Specifically, the cured film formed from the curable composition according to the exemplary embodiment under the above-described conditions has the P2 of 20 μN or less. The load amount P2 is preferably 10 μN or less, and more preferably 8 μN or less. Although the lower limit of the P2 is not particularly limited, it can be 1 μN or more.

In addition, the cured film has a relaxation rate of 15% or more, the relaxation rate being obtained by the expression ((P1−P2)/P1×100). The relaxation rate is preferably 20% or more, and more preferably 25% or more. Although the upper limit of the relaxation rate is not particularly limited, it can be set to 40% or less.

In the present embodiment, the content of the monofunctional polymerizable compound having a melting point of 25° C. or less is 5% by mass or more and 50% by mass or less and the content of the polyfunctional polymerizable compound is 50% by mass or more and 95% by mass or less, based on the total mass of the polymerizable compounds contained in the curable composition.

The monofunctional polymerizable compound having a melting point of 25° C. or less makes the cured film flexible when polymerized, and lowers the load amount P2. The reason therefor is considered that the polymerizable compound forms a side chain having low crystallinity when the polymerizable compound is polymerized. The side chain is present in a movable state in the cured film, and when a continuous load is applied to the cured film, the side chain moves in the cured film to take a stable state corresponding to the direction of the load. Due to the movement of the side chain, the cured film is deformed while relaxing the stress. Therefore, the polymerizable compound can greatly increase the relaxation rate of the cured film and decrease P2.

On the other hand, the polyfunctional polymerizable compound increases the strength of the cured film and increases the load amount P1. In addition, it is considered that since the load amount P2 decreases due to the monofunctional polymerizable compound having a melting point of 25° C. or less and the P1 increases due to the polyfunctional polymerizable compound, a cured film that satisfies both of the conditions (1) and (2) is obtained.

From the viewpoint of achieving a balance between these, the content of the monofunctional polymerizable compound having a melting point of 25° C. or less is preferably 10% by mass or more and 60% by mass or less and more preferably 20% by mass or more and 40% by mass or less based on the total mass of the polymerizable compounds. In addition, the content of the polyfunctional polymerizable compound is preferably 20% by mass or 5 more and 90% by mass or less, more preferably 40% by mass or more and 70% by mass or less.

Examples of the monofunctional polymerizable compound having a melting point of 25° C. or less include 2-hydroxyethyl acrylate, 2-hydroxypropyl acrylate, 4-hydroxybutyl acrylate, isobutyl acrylate, t-butyl acrylate, and isooctyl acrylate. 2-Methoxyethyl acrylate, methoxytriethylene glycol acrylate, 2-ethoxyethyl acrylate, 3-methoxybutyl acrylate, ethoxyethyl acrylate are also included. Butoxyethyl acrylate, ethoxydiethylene glycol acrylate, methoxydipropylene glycol acrylate, dipropylene glycol acrylate, β-carboxylethyl acrylate are also included. Examples of the monofunctional polymerizable compound having a melting point of 25° C. or less include ethyl diglycol acrylate, trimethylolpropane formal monoacrylate, imide acrylate, isoamyl acrylate, and ethoxylated succinic acid acrylate. Examples of the monofunctional polymerizable compound having a melting point of 25° C. or less also include trifluoroethyl acrylate, ω-carboxypolycaprolactone monoacrylate, N-vinylformamide, cyclohexyl acrylate, and tetrahydrofurfuryl acrylate. Bbenzyl acrylate, methylphenoxyethyl acrylate, 4-t-butylcyclohexyl acrylate are also included. Caprolactone-modified tetrahydrofurfuryl acrylate, tribromophenyl acrylate, and ethoxylated tribromophenyl acrylate are included. 2-Phenoxyethyl acrylate (or an ethylene oxide or propylene oxide addition monomer thereof), acryloylmorpholine, isobornyl acrylate, and phenoxydiethylene glycol acrylate are also included. Vinylcaprolactam, vinylpyrrolidone, 2-hydroxy-3-phenoxypropyl acrylate, 1,4-cyclohexanedimethanol monoacrylate, and the like are also included.

From the viewpoint of forming a low crystalline and movable site in the side chain to make the cured film more flexible (to make P2 lower), the monofunctional polymerizable compound preferably includes a monofunctional polymerizable compound having a melting point of 25° C. or less and a molecular weight of 280 or more. In addition, increasing the proportion of such a monofunctional polymerizable compound having a relatively large molecular weight can also enhance the abrasion resistance of the cured film, and enhance the continuous ejection stability when the curable composition is ejected from an inkjet head. The monofunctional polymerizable compound preferably has a molecular weight of 300 or more. The upper limit of the molecular weight is not particularly limited, but may be 1000 or less.

The content of the monofunctional polymerizable compound having a melting point of 25° C. or less and a molecular weight of 280 or more is preferably 10% by mass or more and 60% by mass or less, more preferably 20% by mass or more and 40% by mass or less, based on the total mass of the polymerizable compounds.

Examples of the polyfunctional polymerizable compound include triethylene glycol di(meth)acrylate, tetraethylene glycol di(meth)acrylate, polyethylene glycol di(meth)acrylate, and dipropylene glycol di(meth)acrylate. Tripropylene glycol di(meth)acrylate, polypropylene glycol di(meth)acrylate, 1,4-butanediol di(meth)acrylate, 1,6-hexanediol di(meth)acrylate are also included. Examples of the polyfunctional polymerizable compound further include 1,9-nonanediol di(meth)acrylate, neopentyl glycol di(meth)acrylate, and neopentyl glycol hydroxypivalate di(meth)acrylate. Difunctional (meth)acrylates such as polytetramethylene glycol di(meth)acrylate and tricyclodecanedimethanol di(meth)acrylate are also included. Trimethylolpropane tri(meth)acrylate, pentaerythritol tri(meth)acrylate, and pentaerythritol tetra(meth)acrylate are also included. Dipentaerythritol hexa(meth)acrylate and ditrimethylolpropane tetra(meth)acrylate are also included. (Meth)acrylates having three or more functional groups such as glycerin propoxy tri(meth)acrylate and pentaerythritol ethoxy tetra(meth)acrylate are also included.

From the viewpoint of forming a low crystalline and movable site in the cured film to make the cured film more flexible (to make P2 lower), the polymerizable compound is preferably a compound having a cyclic structure. The type of the cyclic structure is not particularly limited and the cyclic structure may be alicyclic or an aromatic ring, but the cyclic structure is preferably an aromatic ring, and more preferably a benzene ring. The polymerizable compound having a cyclic structure may be a monofunctional polymerizable compound or a polyfunctional polymerizable compound. Among these, a monofunctional polymerizable compound is preferable from the viewpoint of further enhancing the stress relaxing property by forming a movable cyclic structure in a side chain.

Examples of the polymerizable compound having a cyclic structure include phenyl (meth)acrylate, phenoxyethyl (meth)acrylate, and 2-hydroxy-3-phenoxypropyl (meth)acrylate. Cumylphenoxyl ethyl (meth)acrylate, tetrahydrofurfuryl (meth)acrylate, and isobornyl (meth)acrylate are also included. (5-ethyl-1,3-dioxane-5-yl) methyl (meth)acrylate, cyclohexyl (meth)acrylate, t-butylcyclohexyl (meth)acrylate, and N-vinylcaprolactam, and the like are also included.

The content of the polymerizable compound having a cyclic structure is preferably 10% by mass or more and 60% by mass or less, more preferably 20% by mass or more and 40% by mass or less, based on the total mass of the polymerizable compounds.

Note that the polymerizable compound may include a monofunctional polymerizable compound having a melting point higher than 25° C. Examples of monofunctional polymerizable compounds having melting points higher than 25° C. include octadecyl (meth)acrylate, tris (2-(meth) acryloyloxyethyl) isocyanurate, stearyl (meth)acrylate, behenyl (meth)acrylate, and the like.

From the viewpoint of further lowering the load amount P2 of the cured film, the content of the monofunctional polymerizable compound having a melting point of higher than 25° C. is preferably less than 3% by mass, more preferably less than 1% by mass, and still more preferably less than 0.1% by mass, based on the total mass of the polymerizable compounds.

The content of the polymerizable compound can be set to 1% by mass to 97% by mass with respect to the total mass of the curable composition. The content is preferably 30% by mass or more and 95% by mass or less. The content is more preferably 50% by mass or more and 95% by mass or less. The content is more preferably 70% by mass or more and 95% by mass or less.

### 1-2. Other Components

The curable composition may further contain other components such as a polymerization initiator, a gelling agent, a pigment, a dye, a surfactant, a fluorescent brightener, and a polymerization inhibitor.

The polymerization initiator may be a compound which initiates polymerization of a polymerizable compound by irradiation with active rays. For example, when the polymerizable compound includes a radically polymerizable compound, the polymerization initiator can be a radical polymerization initiator, and when the polymerizable compound includes a cationically polymerizable compound, the polymerization initiator can be a cationic polymerization initiator (photoacid generator). Note that the polymerization initiator is not required when the curable composition can be sufficiently cured without the polymerization initiator, for example, when the curable composition is cured by irradiation with an electron beam.

The radical polymerization initiator may be an intramolecular bond cleavage type radical polymerization initiator or an intramolecular hydrogen abstraction type radical polymerization initiator.

Examples of the intramolecular bond cleavage type radical polymerization initiator include diethoxyacetophenone, 2-hydroxy-2-methyl-1-phenylpropan-1-one, benzyl dimethyl ketal, and 1-(4-isopropylphenyl)-2-hydroxy-2-methylpropan-1-one. 4-(2-Hydroxyethoxy)phenyl-(2-hydroxy-2-propyl) ketone, 1-hydroxycyclohexyl-phenyl ketone, and 2-methyl-2-morpholino (4-methylthiophenyl) propan-1-one are also included. Acetophenone-based initiators including 2-benzyl-2-dimethylamino-1-(4-morpholinophenyl)-butanone and the like are also included. Benzoins including benzoin, benzoin methyl ether, benzoin isopropyl ether, and the like are also included. Acylphosphine oxide-based initiators including 2,4,6-trimethylbenzoindiphenylphosphine oxide are also included. Benzyl and methylphenyl glyoxy esters and the like are also included.

Examples of the intramolecular hydrogen abstraction type radical polymerization initiator include benzophenone, methyl o-benzoylbenzoate, 4-phenylbenzophenone, 4,4′-dichlorobenzophenone, and hydroxybenzophenone. 4-Benzoyl-4′-methyl-diphenyl sulfide, acrylated benzophenone, 3,3′,4,4′-tetra (t-butylperoxycarbonyl) benzophenone are also included. Benzophenone-based initiators including 3,3′-dimethyl-4-methoxybenzophenone and the like are also included. Thioxanthone-based initiators including 2-isopropylthioxanthone, 2,4-dimethylthioxanthone, 2,4-diethylthioxanthone, 2,4-dichlorothioxanthone, and the like are also included. Aminobenzophenone-based initiators including Michler's ketone, 4,4′-diethylaminobenzophenone, and the like are also included. 10-Butyl-2-chloroacridone, 2-ethylanthraquinone, 9,10-phenanthrenequinone, camphorquinone, and the like are also included.

Examples of the cationic polymerization initiator include photoacid generators. Examples of the photoacid generator include B(C₆F₅)₄⁻, PF₆⁻, AsF₆⁻, SbF₆⁻, CF₃SO₃⁻ salts of aromatic onium compounds including diazonium, ammonium, iodonium, sulfonium, and phosphonium. Sulfonates that generates sulfonic acid, halides that photogenerates a hydrogen halide, and an iron-allene complex are also included.

The content of the polymerization initiator is not particularly limited as long as the content is in a range in which the curable composition is sufficiently cured by irradiation with active rays (for example, ultraviolet rays). For example, the content of the polymerization initiator is preferably 0.1% by mass or more and 20% by mass or less, more preferably 1% by mass or more and 10% by mass or less, based on the total mass of the curable composition.

The gelling agent is a compound that causes the curable composition to be in a gel state at room temperature (25° C.) and to be in a sol state when heated (e.g., 80° C.). For example, the gelling agent is preferably a compound that dissolves in liquid components (such as the polymerizable compound and the organic solvent) contained in the curable composition at a temperature higher than the gelation temperature of the curable composition and crystallizes at a temperature lower than or equal to the gelation temperature of the curable composition. The gelation temperature means a temperature at which, when a curable composition that has been solated or liquefied by heating is cooled, the curable composition undergoes a phase transition from a sol to a gel and the viscosity of the curable composition suddenly changes. Specifically, when the solated or liquefied curable composition is cooled while measuring the viscosity thereof with a rheometer (for example, MCR300 manufactured by Anton Paar GmbH), the temperature at which the viscosity rapidly increases can be defined as the gelation temperature of the curable composition.

The gelling agent can increase the flexibility of the cured film to lower the load amount P2. In addition, due to this, it is possible to increase the stress relaxing property of the cured film by increasing (P1−P2).

The gelling agent is preferably crystallized in the curable composition at a temperature equal to or lower than the gelation temperature of the curable composition to form a structure in which the polymerizable compound is included in a three dimensional space formed by the gelling agent crystallized in a plate shape. Such a structure is hereinafter referred to as a “card house structure”. The gelling agent forming the card house structure can make the cured film less likely to be broken at the time of folding processing and the like. In addition, the gelling agent that forms a card house structure has an improved pinning property when the curable composition is applied to a base material by an inkjet method, and thus it is possible to form a cured film which is more finely patterned or in which dots are disposed with high definition.

Examples of the gelling agent that easily forms a card house structure include aliphatic ketone, aliphatic ester, and petroleum-based wax. Vegetable waxes, animal waxes, mineral waxes, hydrogenated castor oil, modified waxes are included. Fatty acid amides which include higher fatty acids, higher alcohols, hydroxystearic acid, N-substituted fatty acid amides and special fatty acid amides are also included. Higher amines, esters of sucrose fatty acids, synthetic waxes, dibenzylidene sorbitol, dimer acids and dimer diols are also included.

Examples of the aliphatic ketone include dilignoceryl ketone, dibehenyl ketone, distearyl ketone, dieicosyl ketone, dipalmityl ketone, dilauryl ketone, dimyristyl ketone, myristyl palmityl ketone, and palmityl stearyl ketone.

Examples of the aliphatic ester include behenyl behenate, icosyl icosanoate, stearyl stearate, palmityl stearate, myristyl myristate. Fatty acid esters of monoalcohols, such as cetyl myristate and oleyl palmitate; and glycerol fatty acid ester are also included. Fatty acid esters of polyhydric alcohols such as sorbitan fatty acid esters, propylene glycol fatty acid esters, ethylene glycol fatty acid esters, and polyoxyethylene fatty acid esters are also included.

Examples of commercially available products of the aliphatic ester include EMALEX series (manufactured by Nippon Emulsion Co., Ltd. (“EMALEX” is a registered trademark of the company)). The Rikemal series and the Poem series (manufactured by Riken Vitamin Co., Ltd. (“Rikemal” and “Poem” are both registered trademarks of the company)) are also included.

Examples of the higher fatty acid include behenic acid, arachidic acid, stearic acid, palmitic acid, myristic acid, lauric acid, oleic acid, and erucic acid.

Examples of the higher alcohol include stearyl alcohol and behenyl alcohol.

Among these, aliphatic ketones, aliphatic esters, higher fatty acids, and higher alcohols are preferable as the gelling agent from the viewpoint of forming a strong card house structure so as to be less likely to be broken during folding processing or the like. The aliphatic ketone is more preferably an aliphatic ketone represented by the following General formula (G1) or an aliphatic ester represented by the following General formula (G2). One type of gelling agent may be included, or two or more types of gelling agents may be included in combination.

Rₐ—CO—R_{b} General formula (G1):

R_{c}—COO—R_{d} General formula (G2):

In General formula (G1), Rₐ and R_{b} each independently represent a linear hydrocarbon group which has 12 or more and 26 or less carbon atoms and may have a branched chain. In General formula (G2), R_{c} and R_{d} each independently represent a linear hydrocarbon group which has 12 or more and 26 or less carbon atoms and may have a branched chain.

The gelling agents represented by General formulae (G1) and (G2) have high crystallinity since the number of carbon atoms of Rₐ to R_{d} is 12 or more, and a sufficiently wide space is generated inside the card house structure. Therefore, the effect of improving the fold crack resistance due to inclusion of the polymerizable compound (A) is more sufficiently exhibited.

In addition, in the gelling agent represented by General formula (G1) and (G2), the number of carbon atoms of Rₐ to R_{d} is 26 or less. Therefore, the gelling agent has an appropriately low melting point, and does not excessively increase the sol-forming temperature of the curable composition when used as an inkjet ink. Therefore, it is possible to lower the heating temperature of the inkjet ink at the time of ejection.

Examples of the aliphatic ketone represented by the General formula (G1) include dilignoceryl ketone (23-24 carbon atoms), dibehenyl ketone (21-22 carbon atoms), distearyl ketone (17-18 carbon atoms). Dieicosyl ketone (19-20 carbon atoms), dipalmityl ketone (15-16 carbon atoms), dimyristyl ketone (13-14 carbon atoms), dilauryl ketone (11-12 carbon atoms) are also included. Luryl myristyl ketone (11-14 carbon atoms), lauryl palmityl ketone (11-16 carbon atoms), myristyl palmityl ketone (13-16 carbon atoms), and myristyl stearyl ketone (13-18 carbon atoms) are also included. Mristyl behenyl ketone (13-22 carbon atoms), palmityl stearyl ketone (15-18 carbon atoms), and valmityl behenyl ketone (15-22 carbon atoms) are also included. Stearyl behenyl ketone (17-22 carbon atoms) and the like are also included. The number of carbon atoms in the above parentheses represents the number of carbon atoms of each of two hydrocarbon groups separated by a carbonyl group.

Examples of commercially available products of the compound represented by General formula (G1) include 18-Pentatriacontanon and Hentriacontan-16-on (all manufactured by Alfa Aeser), and KAO WAX T1 (manufactured by Kao Corporation).

Examples of the aliphatic ester represented by the General formula (G2) include behenyl behenate (21-22 carbon atoms), icosyl icosanoate (19-20 carbon atoms), stearyl stearate (17-18 carbon atoms), and palmityl stearate (17-16 carbon atoms). Lauryl stearate (17-12 carbon atoms), cetyl palmitate (15-16 carbon atoms), stearyl palmitate (15-18 carbon atoms), and myristyl myristate (13-14 carbon atoms) are also included. Cetyl myristate (13-16 carbon atoms), octyldodecyl myristate (13-20 carbon atoms), stearyl oleate (17-18 carbon atoms), and stearyl erucate (21-18 carbon atoms) are also included. Stearyl linoleate (17-18 carbon atoms) and behenyl oleate (18-22 carbon atoms) are also included. Arachidyl linoleate (17-20 carbon atoms) and the like are included. The number of carbon atoms in the above parentheses represents the number of carbon atoms of each of the two hydrocarbon groups separated by the ester group.

Examples of commercially available products of the aliphatic ester represented by the General formula (G2) include Unister M-2222SL, SPERMACETI, Nissan Electol WEP-2, and Nissan Electol WEP-3 (all manufactured by NOF Corporation, “Unister” and “Nissan Electol” are registered trademarks of the same company). Exepearl SS and Exepearl MY-M (both manufactured by Kao Corporation, “Exepearl” is a registered trademark of the company) are also included. EMALEX CC-18 and EMALEX CC-10 (manufactured by Nippon Emulsion Co., Ltd., “EMALEX” is a registered trade mark of the company) are also included. AMREPS PC (manufactured by Kokyu Alcohol Kogyo Co., Ltd., “AMREPS” is a trademark of the company) and the like are also included. These commercially available products are often mixtures of two or more types, and therefore, may be separated and purified as necessary to be contained in the curable composition.

The content of the gelling agent is preferably 0.5% by mass or more and 10% by mass or less, more preferably 0.5% by mass or more and 8% by mass or less, and still more preferably 1% by mass or more and 6% by mass or less, based on the total mass of the curable composition. As the content of the gelling agent increases, the cured film is less likely to be broken during folding processing or the like, and the pinning property of the curable composition can be further enhanced.

Examples of the pigment include known red pigments, yellow pigments, blue pigments, black pigments, and white pigments. Examples of the dye include known red dyes, yellow dyes, black dyes, and blue dyes.

Examples of the surfactant include anionic surfactants such as dialkylsulfosuccinates, alkylnaphthalenesulfonates, and fatty acid salts. Polyoxyethylene alkyl ethers and polyoxyethylene alkyl allyl ethers are also included. Nonionic surfactants such as acetylene glycols and polyoxyethylene-polyoxypropylene block copolymers are also included. Cationic surfactants such as alkylamine salts and quaternary ammonium salts are also included. Silicone-based and fluorine-based surfactants and the like are also included.

The content of the surfactant is not particularly limited, but can be, for example, 0.001% by mass or more and less than 1.0% by mass with respect to the total mass of the curable composition.

Examples of the polymerization inhibitor include N-oxyl-based polymerization inhibitors, a phenol-based polymerization inhibitors, quinone-based polymerization inhibitors, amine-based polymerization inhibitors, and copper dithiocarbamate-based polymerization inhibitors. Only one polymerization inhibitor may be contained in the curable composition, or two or more polymerization inhibitors may be contained in combination.

Examples of the N-oxyl-based polymerization inhibitor include 4-hydroxy-2,2,6,6-tetramethylpiperidine-N-oxyl (TEMPO) and 4-hydroxy-2,2,6,6-tetramethyl-piperidine-N-oxyl. 4-Oxo-2,2,6,6-tetramethyl-piperidine-N-oxyl, 4-methoxy-2,2,6,6-tetramethyl-piperidine-N-oxyl are also included. 4-Acetoxy-2,2,6,6-tetramethyl-piperidine-N-oxyl and the like are also included. Examples of commercially available products of the N-oxyl-based polymerization inhibitor include Irgastab UV10 (manufactured by BASF (“Irgastab” is a registered trade mark of the company)).

Examples of the phenol-based polymerization inhibitor include 2,6-di-tert-butylphenol, 2,4-di-tert-butylphenol, and 2-tert-butyl 4,6-dimethylphenol. 2,6-Di-tert-butyl-4-methylphenol and 2,4,6-tri-tert-butylphenol are also included. 2,6-Di-t-butyl-p-cresol (butylated hydroxytoluene BHT), 4-methoxyphenol, 2-methoxy-4-methylphenol, and the like are also included.

Examples of the quinone-based polymerization inhibitor include hydrochinone, methoxyhydroquinone, benzoquinone, 1,4-naphthoquinone, p-tert-butylcatechol and the like.

Examples of the amine-based polymerization inhibitor include alkylated diphenylamine, N,N′-diphenyl-p-phenylenediamine, and phenothiazine.

Examples of the copper dithiocarbamate-based polymerization inhibitor include copper dimethyldithiocarbamate, copper diethyldithiocarbamate, copper dibutyldithiocarbamate and the like.

The content of the polymerization inhibitor is not particularly limited, but can be, for example, 0.01% by mass or more and 0.5% by mass or less based on the total mass of the curable composition.

### 1-3. Physical Properties of Curable Composition

The curable composition may be an inkjet ink that can be ejected from a nozzle of an inkjet head, or may be a composition that can be applied to a base material by a method such as a dispenser, a bar coater, a screen roller, or spray coating.

In the case of an inkjet ink, the curable composition preferably has a viscosity at 60° C. of 10 mPa·s or more and 25 mPa·s or less. Thus, in the inkjet head, it is possible to improve the ejection property when the ink is heated and ejected.

The viscosity can be measured by a rheometer. For example, the precoat agent is heated to 100° C. While measuring the viscosity with a stress control type rheometer, the ink is cooled to 20° C. under conditions of a shear rate of 11.7 (1/s) and a temperature decrease rate of 0.1° C./s, thereby obtaining a temperature change curve of the viscosity. The viscosity can be determined by reading the viscosity at 80° C. from the obtained temperature change curve. The stress control-type rheometer is a Physica MCR301 (using a cone-plate diameter of 75 mm and a cone angle of) 1.0° manufactured by AntonPaar GmbH.

### 1-4. Method for Preparing Curable Composition

The curable composition can be prepared by mixing the above-described polymerizable compound and optionally other components under heating. At this time, the obtained mixed liquid is preferably filtered through a predetermined filter. Note that when the pigment-containing curable composition is prepared, it is preferable to prepare a pigment dispersion liquid containing the pigment and the polymerizable compound, and then mix the pigment dispersion liquid with other components. The pigment dispersion liquid may further contain a dispersant.

The pigment dispersion liquid can be prepared by dispersing a pigment in a polymerizable compound. The pigment may be dispersed using, for example, a ball mill, a sand mill, an attritor, a roll mill, an agitator, a Henschel mixer, a colloid mill, an ultrasonic homogenizer, a pearl mill, a wet jet mill, or a paint shaker.

### 2. Image Forming Method

The above-described curable composition can be used for forming a cured film by applying the curable composition to a base material, and then curing the applied curable composition by irradiation with active rays.

The application method to the base material is not limited, and the application can be performed by various methods such as a bar coating method, a spray coating method, a curtain coating method, a roll coating method, a screen printing method, an offset printing method, a gravure printing method, a dispenser method, and an inkjet method. Among these, an inkjet method is preferable because a fine pattern or a high-definition image is easily formed.

In the inkjet method, the ejection method from an inkjet head may be either an on-demand method or a continuous method. The inkjet head of the on-demand system may be of an electromechanical conversion system, such as a single cavity type, a double cavity type, a bender type, a piston type, a share mode type, and a shared wall type. Alternatively, an electrothermal conversion method such as a thermal inkjet method or a bubble jet (“bubble jet” is a registered trademark of Canon Inc) method may be employed. In addition, the inkjet head may be either a scan type or a line type inkjet head.

The curable composition is preferably heated and applied to the base material. The heating temperature is not particularly limited, but can be 60° C. or more. When the curable composition contains a gelling agent, the heating temperature is preferably set to a temperature at which the curable composition is solated, and more preferably set to the gelation temperature +10° C. or more and the gelation temperature +30° C. or less. The heating temperature can be a temperature at the time of ejection from an inkjet head when applied to a base material by an inkjet method.

The base material is not particularly limited, and various base materials such as paper, plastics, resins and metals can be used. As the paper, for example, normal uncoated paper, coated paper and the like, as well as synthetic paper YUPO (“YUPO” is a registered trademark of Yupo Corporation) and the like can be used. As the plastic, for example, a film such as a PP film, a PET film, an OPS film, an OPP film, an ONy film, a PVC film, a PE film, or a TAC film can be used. In addition, molded products of polycarbonate, (meth)acrylic resin, ABS, polyacetal, PVA, rubbers, and the like can be used. These plastics may be films used for flexible packaging.

The curable composition may be directly applied to the base material, or may be applied to an intermediate transfer member and then transferred and applied to the base material from the intermediate transfer member.

The active ray with which the curable composition applied to the base material is irradiated may be an electron beam, an ultraviolet ray, an α-ray, a γ-ray, an X-ray, or the like, and an ultraviolet ray and an electron beam are preferable. The ultraviolet rays are preferably light having peak wavelengths in a range of 360 nm or more and 410 nm or less. Furthermore, the ultraviolet rays are preferably emitted from an LED light source. An LED emits less radiant heat than a conventional light source (e.g., a metal halide lamp). Therefore, in the LED, the curable composition is less likely to be dissolved at the time of irradiation with active rays, and gloss unevenness or the like is less likely to occur.

The cumulative light amount of the active rays to be irradiated may be 100 mJ/cm² or more and 1000 mJ/cm² or less. The curable composition has good curability. Therefore, the cumulative light amount of light can be 600 mJ/cm² or less, and is preferably 100 mJ/cm² or more and 600 mJ/cm² or less. When the cumulative light amount of light is reduced, the curable composition can be cured in a short time, and it becomes easy to cope with high-speed printing of an image by, for example, an inkjet method.

### 3. Cured Film Forming Apparatus

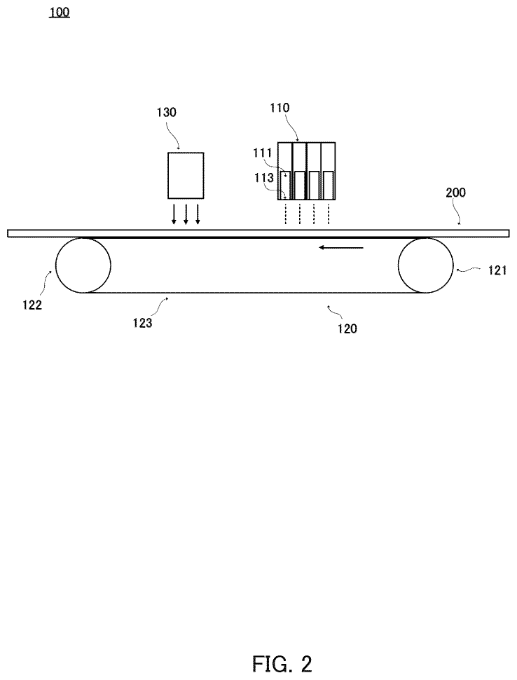

FIG. 2 is a schematic view illustrating a configuration of an apparatus 100 for forming a cured film using the curable composition described above. As illustrated in FIG. 2, the apparatus 100 includes an application section 110 that applies a curable composition to a base material, a conveyance section 120, and an irradiation section 130. Note that the apparatus 100 illustrated in FIG. 2 is an example of an image forming apparatus that forms an image by an inkjet method, and the application section 110 is an inkjet head. Furthermore, in FIG. 2, an arrow indicates a conveyance direction of the base material.

The application section 110 which is an inkjet head includes, on a surface facing the conveyance section 120, a nozzle surface 113 provided with ejection ports of the nozzles 111, and ejects the curable composition onto the base material 200 conveyed by the conveyance section 120. From the viewpoint of enhancing the ejectability of the curable composition, the application section 110 may have a temperature adjustment device for adjusting the temperature of the curable composition to adjust the viscosity of the curable composition to be low. Examples of the temperature adjusting means include heating means using a panel heater, a ribbon heater, and heat-retaining water. The heating temperature is, for example, 60° C. or more.

The application section 110 may be a scan-type inkjet head in which the width in the direction orthogonal to the transport direction of the base material is smaller than the base material 200, or may be a line-type inkjet head in which the width in the direction orthogonal to the transport direction of the base material is larger than the base material 200.

The nozzle 111 has an ejection port in the nozzle surface 113. The number of nozzles 111 may be equal to or greater than the number of inks used for image formation (for example, four).

The conveyance section 120 conveys the base material 200 so that the base material 200 facing the application section 110 moves immediately below the application section 110 in the vertical direction when an image is formed. For example, the conveyance section 120 includes a driving roller 121, a driven roller 122, and a transport belt 123.

Irradiation section 130 irradiates the upper surface of the conveyance section 120 with active rays. Thus, the droplets of the active ray-curable inkjet ink landed on base material 200 to be conveyed can be irradiated with active rays to cure the droplets. The irradiation section 130 can be disposed immediately above the conveyance section 120 on the downstream side from the application section 110. In the present embodiment, the irradiation section 130 is an LED that emits ultraviolet rays. The light amount of the irradiation unit 130 can be set to an amount at which the cumulative light amount of the active rays with which the curable composition is irradiated is 100 mJ/cm² or more and 1000 mJ/cm² or less, and preferably 100 mJ/cm² or more and 600 mJ/cm² or less.

In addition to the above-described components, the apparatus 100 may include an ink tank (not illustrated) for storing the active ray-curable ink before ejection, and an ink flow path (not illustrated) that allows the ink tank and the application section 110 to communicate with each other so that the ink can flow therethrough. And, it may have a controller (not illustrated) to control the operation of the application section 110, the conveyance section 120 and the irradiation section 130.

The apparatus 100 may also include an intermediate transfer member and a transfer section (neither of which is illustrated). At this time, the application section 110 discharges the active ray-curable inkjet ink onto the intermediate transfer member to land the ink on the surface of the intermediate transfer member, thereby forming an intermediate image formed by aggregation of droplets of the active ray-curable inkjet ink on the surface of the intermediate transfer member. Thereafter, the transfer section transfers the intermediate image from the surface of the intermediate transfer member to the surface of the base material. Next, the irradiation section 130 irradiates the intermediate image transferred onto the surface of the base material with active rays to cure the droplets of the active ray-curable inkjet ink.

### EXAMPLES

In the following, the present invention will be described with reference to an example. The scope of the present invention should not be construed as being limited to the examples.

### 1. Preparation/Synthesis of Materials

The materials used in the preparation of the curable composition are illustrated below.

### 1-1. Pigment Dispersion Liquid

Nine parts by mass of a pigment dispersant (EFKA-7701, manufactured by BASF) and 71 parts by mass of tripropylene glycol diacrylate were placed in a stainless steel beaker, and the mixture was heated and stirred for 1 hour while being heated to 65° C. on a hot plate. Then, the mixture was cooled to room temperature, and 20 parts by weight of the following pigments were added into the stainless steel beaker after stirring, then placed into a glass bottle together with 200 g zirconia beads (size: 0.3 mm, manufactured by NIKKATO CORPORATION) and hermetically sealed. This pigment-containing liquid was subjected to dispersion treatment for 4 hours using a paint shaker, and then the zirconia beads were removed to obtain a pigment dispersion liquid.
Cyan pigment: Pigment Blue 15:4 (Chromofine Blue 6332JC, manufactured by Dainichiseika Color & Chemicals Mfg. Co., Ltd)

### 1-2. Polymerizable Compound

### (Monofunctional Polymerizable Compound)

m1: 4EO modified phenyl acrylate
m2: 4EO modified nonylphenol acrylate
m3: (5-ethyl-1,3-dioxan-5-yl) methyl acrylate
m4: 2-phenoxyethyl acrylate
m5: stearyl acrylate

### (Polyfunctional Polymerizable Compound)

M1: tripropylene glycol diacrylate
M2: polyethylene glycol #400 diacrylate
M3: 9EO modified trimethylolpropane triacrylate
M4: 3EO modified trimethylolpropane triacrylate

### 1-3. Gelling Agent

G1: behenyl stearate
G2: stearon

### 1-4. Photopolymerization Initiator

Initiator 1 (Omnirad TPO-L, IGM Resins B. V. Ltd.).
Initiator 2 (Speedcure 2-ITX, manufactured by Arkema)

### 1-5. Polymerization Inhibitor

Irgasutab UV-10 (manufactured by BASF)

### 1-6. Surfactant

KF-352A (manufactured by Shin-Etsu Chemical Co., Ltd)

### 2 Preparation of Curable Composition

The above-described materials in the proportions described in Table 1 to Table 3 were placed in a beaker, and stirred at 105° C. for 45 minutes. Thereafter, the mixture was filtered through a Teflon (R) 3 μm membrane filter manufactured by ADVANTEC to obtain a curable composition 1 as an active ray-curable inkjet ink. Curable compositions 2 to 18 were obtained in the same manner except that the types and the amounts of the materials were changed.

TABLE 1

| | | | | | Curable composition No | | | | | |
|---|---|---|---|---|---|---|---|---|---|---|
| | | Number of | Melting | | 1 | 2 | 3 | 4 | 5 | 6 |
| | | functional | point | Molecular | Pigment dispersion liquid | | | | | |
| | Type | groups | (° C.) | weight | 12.0 | 12.0 | 12.0 | 12.0 | 12.0 | 12.0 |
| Polymerizable | m1 | 1 | <25 | 324 | 5.0 | 12.5 | | 12.5 | 12.5 | 12.5 |
| compound | m2 | 1 | <25 | 451 | | | 12.5 | | | |
| | m3 | 1 | <25 | 200 | 25.0 | | 12.5 | | 12.5 | 12.5 |
| | m4 | 1 | <25 | 192 | 12.5 | 12.5 | 12.5 | 12.5 | 12.5 | 12.5 |
| | m5 | 1 | 32 | 325 | | | | | | |
| | M1 | 2 | <25 | 300 | 0.2 | 30.3 | 42.8 | 5.3 | 17.8 | 2.8 |
| | M2 | 2 | <25 | 523 | 20.0 | | | | | |
| | M3 | 3 | <25 | 693 | 20.0 | 25.0 | | | 25.0 | |
| | M4 | 3 | <25 | 429 | | | | 50.0 | | 40.0 |

| | | | | | | | |
|---|---|---|---|---|---|---|---|
| Gelling agent | G1 | 0.5 | 0.5 | 0.5 | 0.5 | 0.5 | 0.5 |
| | G2 | 1.5 | 1.5 | 1.5 | 1.5 | 1.5 | 1.5 |
| Additives | Initiator 1 | 2.6 | 5.0 | 5.0 | 5.0 | 5.0 | 5.0 |
| | Initiator 2 | 0.5 | 0.5 | 0.5 | 0.5 | 0.5 | 0.5 |
| | Polymerization inhibitor | 0.1 | 0.1 | 0.1 | 0.1 | 0.1 | 0.1 |
| | Surfactant | 0.1 | 0.1 | 0.1 | 0.1 | 0.1 | 0.1 |

| | | | | | | |
|---|---|---|---|---|---|---|
| Total | 100 | 100 | 100 | 100 | 100 | 100 |

TABLE 2

| | | | | | Curable composition No | | | | | | |
|---|---|---|---|---|---|---|---|---|---|---|---|
| | | Number of | Melting | | 7 | 8 | 9 | 10 | 11 | 12 | 13 |
| | | functional | point | Molecular | Pigment dispersion liquid | | | | | | |
| | Type | groups | (° C.) | weight | 12.0 | 12.0 | 12.0 | 12.0 | 12.0 | 12.0 | 12.0 |
| Polymerizable | m1 | 1 | <25 | 324 | | | 12.5 | 12.5 | 25.0 | 25.0 | 25.0 |
| compound | m2 | 1 | <25 | 451 | 12.5 | 25.0 | 12.5 | 12.5 | 12.5 | 12.5 | 12.5 |
| | m3 | 1 | <25 | 200 | 12.5 | | 12.5 | | | | |
| | m4 | 1 | <25 | 192 | 12.5 | 12.5 | | 12.5 | | | |
| | m5 | 1 | 32 | 325 | | | | | | | |
| | M1 | 2 | <25 | 300 | 22.8 | 22.8 | 22.8 | 42.8 | 17.8 | 42.8 | 22.8 |
| | M2 | 2 | <25 | 523 | 20.0 | 20.0 | 20.0 | | | | 20.0 |
| | M3 | 3 | <25 | 693 | | | | | 25.0 | | |
| | M4 | 3 | <25 | 429 | | | | | | | |

| | | | | | | | | |
|---|---|---|---|---|---|---|---|---|
| Gelling agent | G1 | 0.5 | 0.5 | 0.5 | 0.5 | 0.5 | 0.5 | 0.5 |
| | G2 | 1.5 | 1.5 | 1.5 | 1.5 | 1.5 | 1.5 | 1.5 |
| Additives | Initiator 1 | 5.0 | 5.0 | 5.0 | 5.0 | 5.0 | 5.0 | 5.0 |
| | Initiator 2 | 0.5 | 0.5 | 0.5 | 0.5 | 0.5 | 0.5 | 0.5 |
| | Polymerization inhibitor | 0.1 | 0.1 | 0.1 | 0.1 | 0.1 | 0.1 | 0.1 |
| | Surfactant | 0.1 | 0.1 | 0.1 | 0.1 | 0.1 | 0.1 | 0.1 |

| | | | | | | | |
|---|---|---|---|---|---|---|---|
| Total | 100 | 100 | 100 | 100 | 100 | 100 | 100 |

TABLE 3

| | | | | | Curable composition No | | | | |
|---|---|---|---|---|---|---|---|---|---|
| | | Number of | Melting | | 14 | 15 | 16 | 17 | 18 |
| | | functional | point | Molecular | Pigment dispersion liquid | | | | |
| | Type | groups | (° C.) | weight | 12.0 | 12.0 | 12.0 | 12.0 | 12.0 |
| Polymerizable | m1 | 1 | <25 | 324 | | | | | 25.0 |
| compound | m2 | 1 | <25 | 451 | | | | | 40.0 |
| | m3 | 1 | <25 | 200 | 12.5 | 12.5 | 12.5 | | |
| | m4 | 1 | <25 | 192 | | | | | |
| | m5 | 1 | 32 | 325 | | | | | |
| | M1 | 2 | <25 | 300 | 17.8 | 2.8 | 42.8 | 30.3 | 15.3 |
| | M2 | 2 | <25 | 523 | | 15.0 | | 25.0 | |
| | M3 | 3 | <25 | 693 | 50.0 | 50.0 | 25.0 | | |
| | M4 | 3 | <25 | 429 | | | | 25.0 | |

| | | | | | | |
|---|---|---|---|---|---|---|
| Gelling agent | G1 | 0.5 | 0.5 | 0.5 | 0.5 | 0.5 |
| | G2 | 1.5 | 1.5 | 1.5 | 1.5 | 1.5 |
| Additives | Initiator 1 | 5.0 | 5.0 | 5.0 | 5.0 | 5.0 |
| | Initiator 2 | 0.5 | 0.5 | 0.5 | 0.5 | 0.5 |
| | Polymerization inhibitor | 0.1 | 0.1 | 0.1 | 0.1 | 0.1 |
| | Surfactant | 0.1 | 0.1 | 0.1 | 0.1 | 0.1 |

| | | | | | |
|---|---|---|---|---|---|
| Total | 100 | 100 | 100 | 100 | 100 |

### 3. Evaluation

Curable composition 1 to Curable composition 18 were subjected to nanoindentation evaluation by the following method. Furthermore, cracking during folding processing, cracking during cutting processing, abrasion resistance, and continuous ejection stability were evaluated according to the following criteria.

Note that the formation of the coating film was performed using an inkjet head having 1776 nozzles manufactured by Konica Minolta, Inc. with a resolving power of 600 dpi. At this time, the applied voltages were adjusted such that the droplet amount of one droplet was 3.5 pl and the droplet speed was 6 m/sec, and two heads were arranged in a staggered pattern to record an image having 1200 dpi×1200 dpi definition. The dpi represents 2. the number of dots per 54 cm. Formation of the image was performed under an environment of 23° C. and 55% RH

### 3-1. Nanoindentation Evaluation

Curable composition 1 to curable composition 18 were used to form coating films having average thicknesses of 8 μm on Oji Paper Co., Ltd. OK Top Coat+A3Y 127.9 g. The coating film was irradiated with ultraviolet rays of wavelengths 395 nm and cumulative light amount of 400 mJ/m² to obtain a cured film. The obtained cured film was allowed to stand in a 25° C. 60% RH environment for 24 hours. Thereafter, the cured film was pressed 100 nm in the thickness direction using a nanoindentation evaluation apparatus (manufactured by TriscopeHysitron, 90° cube Corner Tip indenter). The P1 was defined as a load amount required for pressing the cured film, and the P2 was defined as a load amount after maintaining the pressed state for 2 seconds.

### 3-2. Cracking During Folding Processing

In the same manner, for each of the curable composition 1 to the curable composition 18, a coating film having an average thickness of 8 μm was formed on Oji Paper Co., Ltd. OK Top Coat+A3Y 127.9 g. The coating film was irradiated with ultraviolet rays of wavelengths 395 nm and cumulative light amount of 400 mJ/m² to obtain a cured film. The obtained cured film was allowed to stand in a 25° C. 60% RH environment for 24 hours. Thereafter, the printed product was folded in two (mountain-folded), and the degree of cracking of the folded portion was visually evaluated.
A: No crack and no exposure of white background
B: With cracks but little exposure of white background
C: With cracks and exposure of white background in half region
D: With cracks and exposure of white background in entire region

### 3-3. Cracking During Cutting Processing

In the same manner, for each of the curable composition 1 to the curable composition 18, a coating film having an average thickness of 8 μm was formed on Oji Paper Co., Ltd. OK Top Coat+A3Y 127.9 g. The coating film was irradiated with ultraviolet rays of wavelengths 395 nm and cumulative light amount of 400 mJ/m² to obtain a cured film. The obtained cured film was allowed to stand in a 25° C. 60% RH environment for 24 hours. Thereafter, 10 sheets of the printed matter were stacked and cut by using an automatic cutting machine PC-LA manufactured by P430 Corporation, the cut portion was rubbed with a finger, and the degree of peeling of the first sheet, the fifth sheet, and the tenth sheet was visually evaluated.
A: No peeling
B: Peeling occurs but is not visually recognizable clearly
C: Peeling occurs and is visually recognizable
D: Largely peeled off and visually recognizable clearly

### 3-4. Abrasion Resistance

Similarly, for the curable composition 1 to the curable composition 18, A coating film having an average thickness of 8 μm was formed on Oji Paper Co., Ltd. OK Top Coat+A3Y 127.9 g. The coating film was irradiated with ultraviolet rays of wavelengths 395 nm and cumulative light amount of 400 mJ/m² to obtain a cured film. The resulting cured film was allowed to stand under an environment of 25° C. 60% RH for 24 hours. Thereafter, the surfaces of the cured films were rubbed 10 times back and forth with unprinted paper while applying the load of a 1 kg/2 cm². After the rubbing, the rubbed sheet surface and the unprinted sheet surface were visually evaluated.
A: No change on rubbed paper, no color transfer to unprinted sheet surface
B: No color transfer to unprinted sheet surface
C: Slight color transfer to unprinted sheet surface
D: As color density decreases, color transfer occurs to unprinted sheet surface

### 3-5. Continuous Ejection Stability

For the image output product of each sample, it was visually confirmed whether or not there was a white streak (white streak due to ejection failure) in the 100% printed portion at the time of printing of the 10 th sheet and the 100 th sheet.
A: No occurrence of white spot
B: 1 or 2 white spots, but no practical problem level
C: Large number of white spots occurred

Tables 4 to 6 how the amounts of the monofunctional polymerizable compounds and the polyfunctional polymerizable compounds in the curable composition 1 to the curable composition 18, and the values of the relaxation rate ((P1−P2)/P1×100) calculated from the load amounts P1 and P2 obtained in the nanoindentation evaluation, and P2. Furthermore, evaluation results of cracking during folding processing, cracking during cutting processing, abrasion resistance, and continuous ejection stability are described.

TABLE 4

| | | Remarks | | | | | |
|---|---|---|---|---|---|---|---|
| | | Examples | | | | | |
| Curable composition No | | 1 | 2 | 3 | 4 | 5 | 6 |
| Composition | Monofunctional | 43 | 25 | 38 | 25 | 38 | 38 |
| | polymerizable | | | | | | |
| | composition | | | | | | |
| | Polyfunctional | 49 | 64 | 51 | 64 | 51 | 51 |
| | polymerizable | | | | | | |
| | composition | | | | | | |
| NI | Relaxation rate | 15 | 16 | 18 | 20 | 20 | 24 |
| | P2 | 20 | 16 | 20 | 20 | 18 | 16 |
| Evaluation | Crack during | C | B | B | B | B | B |
| | folding processing | | | | | | |
| | Crack during | B | B | B | A | A | A |
| | cutting process | | | | | | |
| | Abrasion resistance | C | B | B | A | A | A |
| | Continuous | C | B | C | B | C | C |
| | ejection stability | | | | | | |

TABLE 5

| | | Remarks | | | | | | |
|---|---|---|---|---|---|---|---|---|
| | | Examples | | | | | | |
| Curable composition No | | 7 | 8 | 9 | 10 | 11 | 12 | 13 |
| Composition | Monofunctional | 38 | 38 | 38 | 38 | 38 | 38 | 38 |
| | polymerizable | | | | | | | |
| | composition | | | | | | | |
| | Polyfunctional | 51 | 51 | 51 | 51 | 51 | 51 | 51 |
| | polymerizable | | | | | | | |
| | composition | | | | | | | |
| NI | Relaxation rate | 19 | 18 | 21 | 24 | 20 | 25 | 21 |
| | P2 | 9 | 5 | 9 | 9 | 8 | 8 | 4 |
| Evaluation | Crack during | A | A | A | A | A | A | A |
| | folding processing | | | | | | | |
| | Crack during | B | B | A | A | A | A | A |
| | cutting process | | | | | | | |
| | Abrasion resistance | B | B | A | A | A | A | A |
| | Continuous | C | B | B | B | A | A | A |
| | ejection stability | | | | | | | |

TABLE 6

| | | Remarks | | | | |
|---|---|---|---|---|---|---|
| | | Comparative example | | | | |
| Curable composition No | | 14 | 15 | 16 | 17 | 18 |
| Composition | Monofunctional | 13 | 13 | 13 | 0 | 65 |
| | polymerizable | | | | | |
| | composition | | | | | |
| | Polyfunctional | 76 | 76 | 76 | 89 | 24 |
| | polymerizable | | | | | |
| | composition | | | | | |
| NI | Relaxation rate | 15 | 12 | 13 | 8 | 29 |
| | P2 | 22 | 20 | 43 | 20 | 2 |
| Evaluation | Crack during | C | C | D | D | A |
| | folding processing | | | | | |
| | Crack during | C | C | A | B | D |
| | cutting process | | | | | |
| | Abrasion resistance | A | A | A | A | D |
| | Continuous | B | B | C | A | A |
| | ejection stability | | | | | |

From the results of the curable compositions 1 to 18, it is understood that a curable composition in which the content of a monofunctional polymerizable compound having a melting point of 25° C. or less is 5% by mass or more and 50% by mass or less, the content of a polyfunctional polymerizable compound is 50% by mass or more and 95% by mass or less, the P2 of a cured film measured by a nanoindentation evaluation apparatus is 20 μN or less, and the relaxation rate obtained by the expression ((P1−P2)/P1×100) is 15% or more is less likely to be cracked during folding processing and is also less likely to be cracked during cutting processing.

### INDUSTRIAL APPLICABILITY

The curable composition of the present invention can produce a cured film which satisfies both followability to deformation of a base material and suppression of cracking in the vicinity of a cut portion, and in particular, a cured film which suppresses a change in qualities of each base material when a plurality of base materials are stacked and cut. Therefore, the present invention is useful in the field of image formation.

### REFERENCE SIGNS LIST

100 Apparatus
110 Application section
120 Conveyance section
130 Irradiation section
200 Base material

Although embodiments of the present invention have been described and illustrated in detail, the disclosed embodiments are made for purposes of illustration and example only and not limitation. The scope of the present invention should be interpreted by terms of the appended claims.

What is claimed is:

1. A curable composition comprising a polymerizable compound, the curable composition being configured to be cured by irradiation with an active ray, wherein:
a content of a monofunctional polymerizable compound that has a melting point of 25° C. or less is 5% by mass or more and 50% by mass or less based on a total mass of the polymerizable compound;
a content of a polyfunctional polymerizable compound is 50% by mass or more and 95% by mass or less based on the total mass of the polymerizable compound; and
when a nanoindentation evaluator is used to press an indenter into a cured film by 100 nm in a thickness direction of the cured film, P1 is defined as a load amount required for pressing, and P2 is defined as a load amount after the pressing is maintained for 2 seconds, the cured film satisfies both of conditions (1) and (2) below, the cured film being obtained by applying the curable composition to a base material to form a coating film having an average thickness of 8 μm, and curing the coating film by irradiation with an active ray at a cumulative light amount of 400 mJ/m²:
(1) the P2 is 20 μN or less, and
(2) a relaxation rate obtained by an expression ((P1−P2)/P1×100) is 15% or more.

2. The curable composition according to claim 1, wherein
the cured film has the relaxation rate of 20% or more.

3. The curable composition according to claim 1, wherein
the cured film has the P2 of 10 μN or less.

4. The curable composition according to claim 1, wherein
the polymerizable compound comprises a compound having a cyclic structure.

5. The curable composition according to claim 1, wherein
the polymerizable compound comprises a compound having an aromatic ring.

6. The curable composition according to claim 1, wherein
the polymerizable compound comprises a compound having a benzene ring.

7. The curable composition according to claim 1, wherein
the monofunctional polymerizable compound comprises a monofunctional polymerizable compound having a melting point of 25° C. or less and a molecular weight of 280 or more.

8. The curable composition according to claim 1, further comprising:
a gelling agent.

9. The curable composition according to claim 1, wherein
the curable composition is an inkjet ink.

10. A method for producing a cured film, comprising:
applying the curable composition according to claim 1 to a surface of the base material; and
curing the applied curable composition by the irradiation with the active ray.

11. The method according to claim 10, wherein
the applying the curable composition is performed by an inkjet method.

12. The method according to claim 10, wherein
a temperature of the curable composition when the curable composition is applied is 60° C. or more.

13. The method according to claim 10, wherein
a light amount of the active ray used for the irradiation is 600 mJ/cm² or less.
